(19) United States
(12) Patent Application Publication
(10) Pub. No.: US 2020/0063833 A1
(43) Pub. Date: Feb. 27, 2020

(54) MULTI-SPEED TRANSMISSION

(71) Applicants: AISIN AW CO., LTD., Anjo-shi-ken (JP); TOYOTA JIDOSHA KABUSHIK KAISHA, Toyota-shi, Aichi (JP)

(72) Inventors: Takayoshi KATO, Handa (JP); Toshihiko AOKI, Anjo (JP); Hiroshi KATO, Kariya (JP); Terufumi MIYAZAKI, Toyota-shi (JP)

(73) Assignees: AISIN AW CO., LTD., Anjo-shi-ken (JP); TOYOTA JIDOSHA KABUSHIK KAISHA, Toyota-shi, Aichi (JP)

(21) Appl. No.: 16/487,633

(22) PCT Filed: Dec. 5, 2017
(86) PCT No.: PCT/JP2017/043692

§ 371 Date: Aug. 21, 2019

(30) Foreign Application Priority Data
Mar. 31, 2017 (JP) 2017-072101

(51) Int. Cl. F16H 3/66; F16H 37/04

(52) U.S. Cl. CPC F16H 3/66; F16H 37/042; F16H 2200/0069; F16H 2200/0078; F16H 2200/2053; F16H 2200/0073; F16H 2200/2012

(57) ABSTRACT

A first carrier of a first planetary gear is coupled to an input member. A second rotary element of a fourth planetary gear is coupled to an output member. A first ring gear of the first planetary gear, a second sun gear of a second planetary gear, and a first rotary element of the fourth planetary gear are coupled together. A second carrier of the second planetary gear and a third carrier of a third planetary gear are coupled together. A third ring gear of the third planetary gear and a third rotary element of the fourth planetary gear are coupled together. A first engagement element engaging two of the second sun gear, the second carrier, and a second ring gear of the second planetary gear. A fourth engagement element engaging the second ring gear of the second planetary gear and a third sun gear of the third planetary gear.

### TECHNICAL FIELD

The present disclosure relates to multi-speed transmissions.

### BACKGROUND ART

Multi-speed transmissions having single-pinion type first to fourth planetary gears, first to fourth clutches, and first to third brakes have been conventionally proposed as this type of multi-speed transmission (see, e.g., Patent Document 1). This multi-speed transmission establishes first to tenth forward speeds and a reverse speed by selectively engaging three of the first to fourth clutches and the first to third brakes.

### RELATED ART DOCUMENTS

### Patent Documents

Patent Document 1: U.S. Patent Application Publication No. 2016/0327132

### SUMMARY OF THE DISCLOSURE

In the above multi-speed transmission, the first clutch and the fourth clutch are connected to a third carrier of the third planetary gear that has a large torque share. A large number of friction materials is therefore required for these clutches.

This may result in an increased axial length of the multi-speed transmission and may also result in increased drag loss that is caused by the friction materials when these clutches are in a disengaged state, which may reduce efficiency of the multi-speed transmission. In the above multi-speed transmission, a second ring gear of the second planetary gear that has a large diameter rotates at high speeds and has large inertia at the first forward speed etc. Accordingly, it may take time to engage the second clutch and the third clutch which are connected to the second ring gear (shift time may be increased), shift shock may occur during engagement of these clutches, and durability of the friction materials of these clutches may be reduced.

It is an aspect of the present disclosure to implement a lighter, more compact multi-speed transmission and improve efficiency and shifting performance of the multi-speed transmission and durability of engagement elements.

In order to achieve the above aspect, a multi-speed transmission of the present disclosure takes the following measures.

The multi-speed transmission of the present disclosure is a multi-speed transmission that shifts power transmitted to an input member to transmit the shifted power to an output member, including: a first planetary gear, a second planetary gear, a third planetary gear, and a fourth planetary gear; and a first engagement element, a second engagement element, a third engagement element, a fourth engagement element, a fifth engagement element, a sixth engagement element, and a seventh engagement element, each of which connects and disconnects one of rotary elements of the first planetary gear, the second planetary gear, the third planetary gear, and the fourth planetary gear to and from another one of the rotary elements or a stationary member, wherein the first planetary gear is a single-pinion type planetary gear having a first sun gear, a first ring gear, and a first carrier that supports a plurality of first pinion gears such that the plurality of first pinion gears can rotate and revolve, each of the first pinion gears meshing with the first sun gear and the first ring gear, the second planetary gear is a single-pinion type planetary gear having a second sun gear, a second ring gear, and a second carrier that supports a plurality of second pinion gears such that the plurality of second pinion gears can rotate and revolve, each of the second pinion gears meshing with the second sun gear and the second ring gear, the third planetary gear is a single-pinion type planetary gear having a third sun gear, a third ring gear, and a third carrier that supports a plurality of third pinion gears such that the plurality of third pinion gears can rotate and revolve, each of the third pinion gears meshing with the third sun gear and the third ring gear, the fourth planetary gear has a first rotary element, a second rotary element, and a third rotary element, the first carrier of the first planetary gear is constantly coupled to the input member, the second rotary element of the fourth planetary gear is constantly coupled to the output member, the first ring gear of the first planetary gear, the second sun gear of the second planetary gear, and the first rotary element of the fourth planetary gear are constantly coupled together, the second carrier of the second planetary gear and the third carrier of the third planetary gear are constantly coupled together, the third ring gear of the third planetary gear and the third rotary element of the fourth planetary gear are constantly coupled together, the first engagement element connects and disconnects two of the second sun gear, the second carrier, and the second ring gear of the second planetary gear to and from each other, the fourth engagement element connects and disconnects the second ring gear of the second planetary gear and the third sun gear of the third planetary gear to and from each other, and first to tenth forward speeds and a reverse speed, first to eleventh forward speeds and a reverse speed, or first to twelfth forward speeds and a reverse speed are established by selectively engaging three of the first engagement element, the second engagement element, the third engagement element, the fourth engagement element, the fifth engagement element, the sixth engagement element, and the seventh engagement element.

In the multi-speed transmission of the present disclosure, the second carrier of the second planetary gear and the third carrier of the third planetary gear are constantly coupled together, and the fourth engagement element is provided to connect and disconnect the second ring gear of the second planetary gear and the third sun gear of the third planetary gear to and from each other. This can reduce the torque share of the fourth engagement element as compared to a multi-speed transmission in which the fourth engagement element is provided to connect and disconnect the third carrier (the rotary element with a large torque share) of the third planetary gear and the second carrier of the second planetary gear to and from each other like the multi-speed transmission of Patent Document 1 described above. By disengaging the fourth engagement element at a shift speed at which the third sun gear of the third planetary gear rotates at high speeds (e.g., the first forward speed), the second ring gear of the second planetary gear can be disconnected from the third sun gear of the third planetary gear. This can restrain the second ring gear with a large diameter from rotating at high speeds and having large inertia.

In the multi-speed transmission of the present disclosure, the first engagement element is provided to connect and disconnect two of the second sun gear, the second carrier, and the second ring gear of the second planetary gear to and from each other (to allow and not to allow the second sun gear, the second carrier, and the second ring gear to rotate together). This can reduce the torque share of the first engagement element as compared to a multi-speed transmission in which the first engagement element is provided to connect and disconnect the third carrier (the rotary element with a large torque share) of the third planetary gear to and from the first ring gear of the first planetary gear and the fourth sun gear (the rotary element corresponding to the first rotary element of the present disclosure) of the fourth planetary gear like the multi-speed transmission of Patent Document 1 described above.

By thus reducing the torque shares of the first engagement element and the fourth engagement element, the number of friction materials required for the first engagement element and the fourth engagement element can be reduced. This can reduce the axial length of the multi-speed transmission and can also reduce drag loss that is caused by the first engagement element and the fourth engagement element when they are in a disengaged state, whereby efficiency of the multi-speed transmission can be improved. By disengaging the fourth engagement element at the shift speed at which the third sun gear of the third planetary gear rotates at high speeds (e.g., the first forward speed) to restrain the second ring gear of the second planetary gear from having large inertia, the time required to engage the first engagement element can be reduced, shift shock that occurs during engagement of the first engagement element can be restrained, and durability of the friction materials of the first engagement element can be improved. As a result, a lighter, more compact multi-speed transmission can be implemented, and efficiency and shifting performance of the multi-speed transmission and durability of the engagement elements can be improved.

### BRIEF DESCRIPTION OF THE DRAWINGS

FIG. 1 is a configuration diagram schematically showing the configuration of a power transmission device 10 including an automatic transmission 20.

FIG. 2 is a speed diagram showing the ratio of the rotational speed of each rotary element to the rotational speed of an input shaft 20i (input rotational speed) in the case where the automatic transmission 20 is used as a ten-speed transmission.

FIG. 3 is an operation table showing the relationship between each shift speed and the operating state of clutches C1 to C4 and brakes B1 to B3 in the case where the automatic transmission 20 is used as a ten-speed transmission.

FIG. 4 is an operation table showing the relationship between each shift speed and the operating state of the clutches C1 to C4 and the brakes B1 to B3 in the case where the automatic transmission 20 is used as an eleven-speed transmission.

FIG. 5 is an operation table showing the relationship between each shift speed and the operating state of the clutches C1 to C4 and the brakes B1 to B3 in the case where the automatic transmission 20 is used as a twelve-speed transmission.

FIG. 6 is a configuration diagram schematically showing the configuration of a power transmission device 10B including an automatic transmission 20B.

FIG. 7 is a configuration diagram schematically showing the configuration of a power transmission device 10C including an automatic transmission 20C.

FIG. 8 is a configuration diagram schematically showing the configuration of a power transmission device 110 including an automatic transmission 120.

FIG. 9 is a configuration diagram schematically showing the configuration of a power transmission device 110B including an automatic transmission 120B.

FIG. 10 is a configuration diagram schematically showing the configuration of a power transmission device 210 including an automatic transmission 220.

### DETAILED DESCRIPTION

Modes for carrying out the various aspects of the present disclosure will be described below with reference to the accompanying drawings.

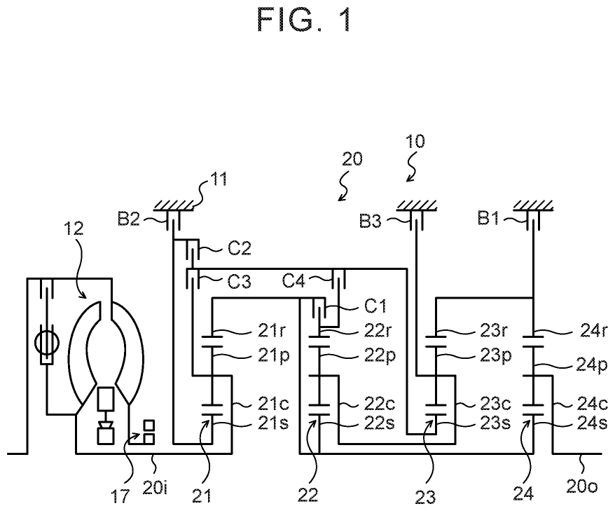

FIG. 1 is a configuration diagram schematically showing the configuration of a power transmission device 10 including an automatic transmission 20 serving as a multi-speed transmission according to an embodiment of the present disclosure. The power transmission device 10 of the present embodiment is connected to a crankshaft of an engine (internal combustion engine), not shown, serving as a driving source longitudinally mounted in a front part of a rear-wheel drive vehicle and can transmit power (torque) from the engine to right and left rear wheels (drive wheels), not shown. As shown in the figure, the power transmission device 10 includes a transmission case 11 serving as a stationary member, a starting device (fluid transmission device) 12, an oil pump 17, etc. in addition to the automatic transmission 20 that shifts power transmitted from the engine to an input shaft 20i serving as an input member to transmit the shifted power to an output shaft 20o serving as an output member.

The starting device 12 includes a torque converter having an input-side pump impeller coupled to the crankshaft of the engine via a front cover, an output-side turbine runner coupled to the input shaft 20i of the automatic transmission 20, a stator disposed inside the pump impeller and the turbine runner to adjust the flow of hydraulic oil from the turbine runner to the pump impeller, a one-way clutch that allows the stator to rotate in only one direction, etc. The starting device 12 further includes a lockup clutch that connects and disconnects the front cover and the input shaft 20i of the automatic transmission 20 to and from each other and a damper mechanism that damps vibration between the front cover and the input shaft 20i of the automatic transmission 20. The fluid transmission device 12 may include a fluid coupling that does not have a stator, instead of the torque converter.

The oil pump 17 is configured as a gear pump including a pump assembly having a pump body and a pump cover, an external gear (inner rotor) coupled to the pump impeller of the fluid transmission device 12, an internal gear (outer rotor) meshing with the external gear, etc. The oil pump 17 is driven by the power from the engine to suck hydraulic oil (ATF) stored in an oil pan, not shown, and pump the sucked hydraulic oil to a hydraulic control device, not shown.

The automatic transmission 20 is configured as a ten- to twelve-speed transmission. As shown in FIG. 1, the automatic transmission 20 includes, in addition to the input shaft 20i serving as an input member connected to the starting device 12 and the output shaft 20o serving as an output member coupled to the right and left rear wheels via a differential gear and drive shafts, both not shown, a single-pinion type first planetary gear 21, a single-pinion type second planetary gear 22, a single-pinion type third planetary gear 23, and a single-pinion type fourth planetary gear 24 which are arranged next to each other in the axial direction of the automatic transmission 20 (the input shaft 20i and the output shaft 20o). The automatic transmission 20 further includes a clutch C1 serving as a first engagement element, a clutch C2 serving as a second engagement element, a clutch C3 serving as a third engagement element, a clutch C4 serving as a fourth engagement element, a brake B1 serving as a fifth engagement element, a brake B2 serving as a sixth engagement element, and a brake B3 serving as a seventh engagement element in order to change a power transmission path from the input shaft 20i to the output shaft 20o.

In the present embodiment, the first to fourth planetary gears 21 to 24 are arranged in the transmission case 11 in this order from the starting device 12 side, namely from the engine side. The clutch C1 is disposed radially outside, e.g., the second planetary gear 22. The clutches C2, C3 and the brake B2 are disposed closer to the starting device 12 than, e.g., the first planetary gear 21 is. The clutch C4 and the brake B3 are disposed in order to connect and disconnect, e.g., the second planetary gear 22 and the third planetary gear 23 to and from each other. The brake B1 is disposed radially outside, e.g., the fourth planetary gear 24.

The first planetary gear 21 has a first sun gear 21s that is an external gear, a first ring gear 21r that is an internal gear disposed concentrically with the first sun gear 21s, a plurality of first pinion gears 21p each meshing with the first sun gear 21s and the first ring gear 21r, and a first carrier 21c supporting the plurality of first pinion gears 21p such that the plurality of first pinion gears 21p can rotate and revolve. In the present embodiment, the gear ratio (the number of teeth of the first sun gear 21s/the number of teeth of the first ring gear 21r) λ1 of the first planetary gear 21 is set to, e.g., λ1=0.350.

The second planetary gear 22 has a second sun gear 22s that is an external gear, a second ring gear 22r that is an internal gear disposed concentrically with the second sun gear 22s, a plurality of second pinion gears 22p each meshing with the second sun gear 22s and the second ring gear 22r, and a second carrier 22c supporting the plurality of second pinion gears 22p such that the plurality of second pinion gears 22p can rotate and revolve. In the present embodiment, the gear ratio (the number of teeth of the second sun gear 22s/the number of teeth of the second ring gear 22r) λ2 of the second planetary gear 22 is set to, e.g., λ2=0.400.

The third planetary gear 23 has a third sun gear 23s that is an external gear, a third ring gear 23r that is an internal gear disposed concentrically with the third sun gear 23s, a plurality of third pinion gears 23p each meshing with the third sun gear 23s and the third ring gear 23r, and a third carrier 23c supporting the plurality of third pinion gears 23p such that the plurality of third pinion gears 23p can rotate and revolve. In the present embodiment, the gear ratio (the number of teeth of the third sun gear 23s/the number of teeth of the third ring gear 23r) λ3 of the third planetary gear 23 is set to, e.g., λ3=0.450.

The fourth planetary gear 24 has a fourth sun gear 24s that is an external gear, a fourth ring gear 24r that is an internal gear disposed concentrically with the fourth sun gear 24s, a plurality of fourth pinion gears 24p each meshing with the fourth sun gear 24s and the fourth ring gear 24r, and a fourth carrier 24c supporting the plurality of fourth pinion gears 24p such that the plurality of fourth pinion gears 24p can rotate and revolve. In the present embodiment, the gear ratio (the number of teeth of the fourth sun gear 24s/the number of teeth of the fourth ring gear 24r) λ4 of the fourth planetary gear 24 is set to, e.g., λ4=0.500.

As shown in FIG. 1, the first carrier 21c of the first planetary gear 21 is constantly coupled (fixed) to the input shaft 20i. The fourth carrier 24c of the fourth planetary gear 24 is constantly coupled to the output shaft 20o. The first ring gear 21r of the first planetary gear 21, the second sun gear 22s of the second planetary gear 22, and the fourth sun gear 24s of the fourth planetary gear 24 are constantly coupled together. The second carrier 22c of the second planetary gear 22 and the third carrier 23c of the third planetary gear 23 are constantly coupled together. The third ring gear 23r of the third planetary gear 23 and the fourth ring gear 24r of the fourth planetary gear 24 are constantly coupled together.

The clutch C1 connects and disconnects the second sun gear 22s of the second planetary gear 22 (and the first ring gear 21r of the first planetary gear 21 and the fourth sun gear 24s of the fourth planetary gear 24) to and from the second ring gear 22r of the second planetary gear 22. When the clutch C1 is engaged (fully engaged), two rotary elements of the second planetary gear 22, namely the second sun gear 22s and the second ring gear 22r, are connected to each other, so that three rotary elements of the second planetary gear 22, namely the second sun gear 22s, the second carrier 22c, and the second ring gear 22r, rotate together. The clutch C2 connects and disconnects the first sun gear 21s of the first planetary gear 21 and the third sun gear 23s of the third planetary gear 23 to and from each other. The clutch C3 connects and disconnects the first carrier 21c of the first planetary gear 21 and the third sun gear 23s of the third planetary gear 23 to and from each other. The clutch C4 connects and disconnects the second ring gear 22r of the second planetary gear 22 and the third sun gear 23s of the third planetary gear 23 to and from each other.

The brake B1 connects the third ring gear 23r of the third planetary gear 23 and the fourth ring gear 24r of the fourth planetary gear 24 to the transmission case 11 serving as a stationary member to non-rotatably hold the third ring gear 23r and the fourth ring gear 24r stationary with respect to the transmission case 11, and releases the third ring gear 23r and the fourth ring gear 24r from the transmission case 11 (rotatably releases the third ring gear 23r and the fourth ring gear 24r from the transmission case 11). The brake B2 connects the first sun gear 21s of the first planetary gear 21 to the transmission case 11 to non-rotatably hold the first sun gear 21s stationary with respect to the transmission case 11, and releases the first sun gear 21s from the transmission case 11. The brake B3 connects the third carrier 23c of the third planetary gear 23 to the transmission case 11 to non-rotatably hold the third carrier 23c stationary with respect to the transmission case 11, and releases the third carrier 23c from the transmission case 11.

Multi-plate friction hydraulic clutches (friction engagement elements) having a hydraulic servo formed by a piston, a plurality of friction engagement plates (e.g., friction plates that are annular members having a friction material bonded to their both surfaces and separator plates that are annular members whose both surfaces are smooth), oil chambers (an engagement oil chamber and a cancel oil chamber) to which hydraulic oil is supplied, etc. are used as the clutches C1 to C4. Multi-plate friction hydraulic brakes having a hydraulic servo formed by a piston, a plurality of friction engagement plates (friction plates and separator plates), oil chambers (an engagement oil chamber and a cancel oil chamber) to which hydraulic oil is supplied, etc. are used as the brakes B1 to B3. The clutches C1 to C4 and the brakes B1 to B3 operate according to supply and discharge of hydraulic oil by the hydraulic control device, not shown.

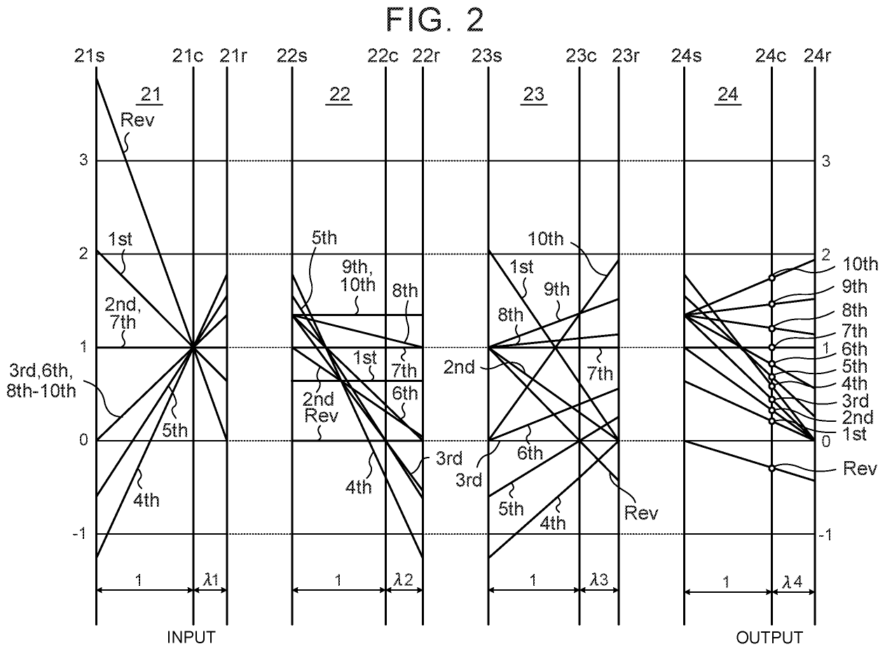

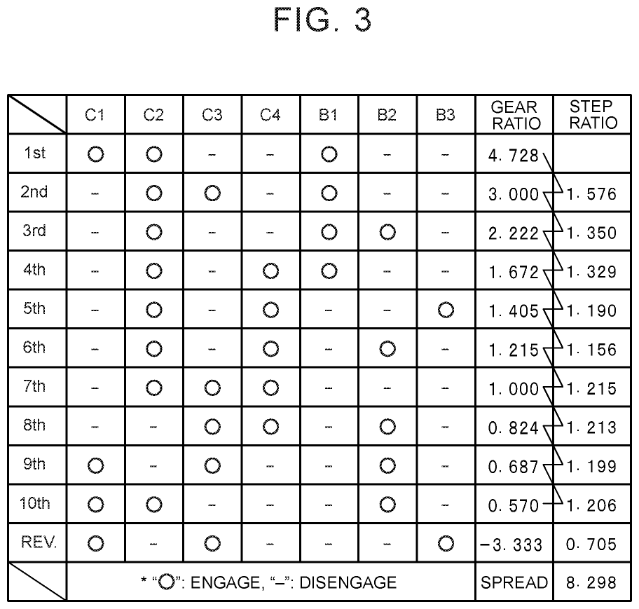

FIG. 2 is a speed diagram showing the ratio of the rotational speed of each rotary element to the rotational speed of the input shaft 20i (the input rotational speed) in the case where the automatic transmission 20 of the present embodiment is used as a ten-speed transmission. In FIG. 2, the value of the rotational speed of the input shaft 20i, namely the second carrier 22c, is 1. FIG. 3 is an operation table showing the relationship between each shift speed and the operating state of the clutches C1 to C4 and the brakes B1 to B3 in the case where the automatic transmission 20 of the present embodiment is used as a ten-speed transmission.

As shown in FIG. 2, three rotary elements of the single-pinion type first planetary gear 21, namely the first sun gear 21s, the first ring gear 21r, and the first carrier 21c, are arranged in order of the first sun gear 21s, the first carrier 21c, and the first ring gear 21r from the left in the figure at intervals corresponding to the gear ratio λ1 on the speed diagram of the first planetary gear 21 (the leftmost speed diagram in FIG. 2). The three rotary elements of the single-pinion type second planetary gear 22, namely the second sun gear 22s, the second ring gear 22r, and the second carrier 22c, are arranged in order of the second sun gear 22s, the second carrier 22c, and the second ring gear 22r from the left in the figure at intervals corresponding to the gear ratio λ2 on the speed diagram of the second planetary gear 22 (the second speed diagram from the left in FIG. 2). Three rotary elements of the single-pinion type third planetary gear 23, namely the third sun gear 23s, the third ring gear 23r, and the third carrier 23c, are arranged in order of the third sun gear 23s, the third carrier 23c, and the third ring gear 23r from the left in the figure at intervals corresponding to the gear ratio λ3 on the speed diagram of the third planetary gear 23 (the third speed diagram from the left in FIG. 2). Three rotary elements of the single-pinion type fourth planetary gear 24, namely the fourth sun gear 24s, the fourth ring gear 24r, and the fourth carrier 24c, are arranged in order of the fourth sun gear 24s, the fourth carrier 24c, and the fourth ring gear 24r from the left in the figure at intervals corresponding to the gear ratio λ4 on the speed diagram of the fourth planetary gear 24 (the rightmost speed diagram in FIG. 2).

In the automatic transmission 20, the clutches C1 to C4 and the brakes B1 to B3 are engaged or disengaged as shown in FIG. 3 to change connection of the rotary elements of the first planetary gear 21, the second planetary gear 22, the third planetary gear 23, and the fourth planetary gear 24. Ten power transmission paths in a forward rotational direction and a single power transmission path in a reverse rotational direction can thus be formed from the input shaft 20i to the output shaft 20o. Namely, any one forward speed out of first to tenth speeds and a reverse speed can thus be established.

Specifically, the first forward speed is established by engaging the clutches C1, C2 and the brake B1 and disengaging the clutches C3, C4 and the brakes B2, B3. That is, when establishing the first forward speed, the second sun gear 22s of the second planetary gear 22 (and the first ring gear 21r of the first planetary gear 21 and the fourth sun gear 24s of the fourth planetary gear 24) is connected to the second ring gear 22r of the second planetary gear 22 by the clutch C1, the first sun gear 21s of the first planetary gear 21 and the third sun gear 23s of the third planetary gear 23 are connected to each other by the clutch C2, and the third ring gear 23r of the third planetary gear 23 and the fourth ring gear 24r of the fourth planetary gear 24 are connected to the transmission case 11 and non-rotatably held stationary with respect to the transmission case 11 by the brake B1. In the present embodiment (in the case where the gear ratios of the first to fourth planetary gears 21 to 24 are λ1=0.350, λ2=0.400, λ3=0.450, and λ4=0.500; the same applies to the following description), the gear ratio (the rotational speed of the input shaft 20i/the rotational speed of the output shaft 20o) γ1 at the first forward speed is γ1=4.728.

The second forward speed is established by engaging the clutches C2, C3 and the brake B1 and disengaging the clutches C1, C4 and the brakes B2, B3. That is, when establishing the second forward speed, the first sun gear 21s of the first planetary gear 21 and the third sun gear 23s of the third planetary gear 23 are connected to each other by the clutch C2, the first carrier 21c of the first planetary gear 21 and the third sun gear 23s of the third planetary gear 23 are connected to each other by the clutch C3, and the third ring gear 23r of the third planetary gear 23 and the fourth ring gear 24r of the fourth planetary gear 24 are connected to the transmission case 11 and non-rotatably held stationary with respect to the transmission case 11 by the brake B1. In the present embodiment, the gear ratio γ2 at the second forward speed is γ2=3.000. The step ratio γ1/γ2 between the first forward speed and the second forward speed is γ1/γ2=1.576.

The third forward speed is established by engaging the clutch C2 and the brakes B1, B2 and disengaging the clutches C1, C3, C4 and the brake B3. That is, when establishing the third forward speed, the first sun gear 21s of the first planetary gear 21 and the third sun gear 23s of the third planetary gear 23 are connected to each other by the clutch C2, the third ring gear 23r of the third planetary gear 23 and the fourth ring gear 24r of the fourth planetary gear 24 are connected to the transmission case 11 and non-rotatably held stationary with respect to the transmission case 11 by the brake B1, and the first sun gear 21s of the first planetary gear 21 is connected to the transmission case 11 and non-rotatably held stationary with respect to the transmission case 11 by the brake B2. In the present embodiment, the gear ratio 73 at the third forward speed is γ3=2.222. The step ratio γ2/γ3 between the second forward speed and the third forward speed is γ2/γ3=1.350.

The fourth forward speed is established by engaging the clutches C2, C4 and the brake B1 and disengaging the clutches C1, C3 and the brakes B2, B3. That is, when establishing the fourth forward speed, the first sun gear 21s of the first planetary gear 21 and the third sun gear 23s of the third planetary gear 23 are connected to each other by the clutch C2, the second ring gear 22r of the second planetary gear 22 and the third sun gear 23s of the third planetary gear 23 are connected to each other by the clutch

C4, and the third ring gear 23r of the third planetary gear 23 and the fourth ring gear 24r of the fourth planetary gear 24 are connected to the transmission case 11 and non-rotatably held stationary with respect to the transmission case 11 by the brake B1. In the present embodiment, the gear ratio γ4 at the fourth forward speed is γ4=1.672. The step ratio γ3/γ4 between the third forward speed and the fourth forward speed is γ3/γ4=1.329.

The fifth forward speed is established by engaging the clutches C2, C4 and the brake B3 and disengaging the clutches C1, C3 and the brakes B1, B2. That is, when establishing the fifth forward speed, the first sun gear 21s of the first planetary gear 21 and the third sun gear 23s of the third planetary gear 23 are connected to each other by the clutch C2, the second ring gear 22r of the second planetary gear 22 and the third sun gear 23s of the third planetary gear 23 are connected to each other by the clutch C4, and the third carrier 23c of the third planetary gear 23 is connected to the transmission case 11 and non-rotatably held stationary with respect to the transmission case 11 by the brake B3. In the present embodiment, the gear ratio γ5 at the fifth forward speed is γ5=1.405. The step ratio γ4/γ5 between the fourth forward speed and the fifth forward speed is γ4/γ5=1.190.

The sixth forward speed is established by engaging the clutches C2, C4 and the brake B2 and disengaging the clutches C1, C3 and the brakes B1, B3. That is, when establishing the sixth forward speed, the first sun gear 21s of the first planetary gear 21 and the third sun gear 23s of the third planetary gear 23 are connected to each other by the clutch C2, the second ring gear 22r of the second planetary gear 22 and the third sun gear 23s of the third planetary gear 23 are connected to each other by the clutch C4, and the first sun gear 21s of the first planetary gear 21 is connected to the transmission case 11 and non-rotatably held stationary with respect to the transmission case 11 by the brake B2. In the present embodiment, the gear ratio γ6 at the sixth forward speed is γ6=1.215. The step ratio γ5/γ6 between the fifth forward speed and the sixth forward speed is γ5/γ6=1.156.

The seventh forward speed is established by engaging the clutches C2, C3, C4 and disengaging the clutch C1 and the brakes B1, B2, B3. That is, when establishing the seventh forward speed, the first sun gear 21s of the first planetary gear 21 and the third sun gear 23s of the third planetary gear 23 are connected to each other by the clutch C2, the first carrier 21c of the first planetary gear 21 and the third sun gear 23s of the third planetary gear 23 are connected to each other by the clutch C3, and the second ring gear 22r of the second planetary gear 22 and the third sun gear 23s of the third planetary gear 23 are connected to each other by the clutch C4. In the present embodiment, the gear ratio γ7 at the seventh forward speed is γ7=1.000. The step ratio γ6/γ7 between the sixth forward speed and the seventh forward speed is γ6/γ7=1.215.

The eighth forward speed is established by engaging the clutches C3, C4 and the brake B2 and disengaging the clutches C1, C2 and the brakes B1, B3. That is, when establishing the eighth forward speed, the first carrier 21c of the first planetary gear 21 and the third sun gear 23s of the third planetary gear 23 are connected to each other by the clutch C3, the second ring gear 22r of the second planetary gear 22 and the third sun gear 23s of the third planetary gear 23 are connected to each other by the clutch C4, and the first sun gear 21s of the first planetary gear 21 is connected to the transmission case 11 and non-rotatably held stationary with respect to the transmission case 11 by the brake B2. In the present embodiment, the gear ratio γ8 at the eighth forward speed is γ8=0.824. The step ratio γ7/γ8 between the seventh forward speed and the eighth forward speed is γ7/γ8=1.213.

The ninth forward speed is established by engaging the clutches C1, C3 and the brake B2 and disengaging the clutches C2, C4 and the brakes B1, B3. That is, when establishing the ninth forward speed, the second sun gear 22s of the second planetary gear 22 (and the first ring gear 21r of the first planetary gear 21 and the fourth sun gear 24s of the fourth planetary gear 24) is connected to the second ring gear 22r of the second planetary gear 22 by the clutch C1, the first carrier 21c of the first planetary gear 21 and the third sun gear 23s of the third planetary gear 23 are connected to each other by the clutch C3, and the first sun gear 21s of the first planetary gear 21 is connected to the transmission case 11 and non-rotatably held stationary with respect to the transmission case 11 by the brake B2. In the present embodiment, the gear ratio γ9 at the ninth forward speed is γ9=0.687. The step ratio γ8/γ9 between the eighth forward speed and the ninth forward speed is γ8/γ9=1.199.

The tenth forward speed is established by engaging the clutches C1, C2 and the brake B2 and disengaging the clutches C3, C4 and the brakes B1, B3. That is, when establishing the tenth forward speed, the second sun gear 22s of the second planetary gear 22 (and the first ring gear 21r of the first planetary gear 21 and the fourth sun gear 24s of the fourth planetary gear 24) is connected to the second ring gear 22r of the second planetary gear 22 by the clutch C1, the first sun gear 21s of the first planetary gear 21 and the third sun gear 23s of the third planetary gear 23 are connected to each other by the clutch C2, and the first sun gear 21s of the first planetary gear 21 is connected to the transmission case 11 and non-rotatably held stationary with respect to the transmission case 11 by the brake B2. In the present embodiment, the gear ratio γ10 at the tenth forward speed is γ10=0.570. The step ratio γ9/γ10 between the ninth forward speed and the tenth forward speed is γ9/γ10=1.206. The spread (gear ratio coverage=the gear ratio γ1 at the first forward speed that is the lowest shift speed/the gear ratio γ10 at the tenth forward speed that is the highest shift speed) in the automatic transmission 20 is γ1/γ10=8.298.

The reverse speed is established by engaging the clutches C1, C3 and the brake B3 and disengaging the clutches C2, C4 and the brakes B1, B2. That is, when establishing the reverse speed, the second sun gear 22s of the second planetary gear 22 (and the first ring gear 21r of the first planetary gear 21 and the fourth sun gear 24s of the fourth planetary gear 24) is connected to the second ring gear 22r of the second planetary gear 22 by the clutch C1, the first carrier 21c of the first planetary gear 21 and the third sun gear 23s of the third planetary gear 23 are connected to each other by the clutch C3, and the third carrier 23c of the third planetary gear 23 is connected to the transmission case 11 and non-rotatably held stationary with respect to the transmission case 11 by the brake B3. In the present embodiment, the gear ratio γrev at the reverse speed is γrev=−3.333. The step ratio γrev/γ11 between the first forward speed and the reverse speed is |γrev/γ1|=0.705.

The first to tenth forward speeds and the reverse speed can thus be established by engaging or disengaging the clutches C1 to C4 and the brakes B1 to B3.

In the automatic transmission 20 of the present embodiment, the second carrier 22c of the second planetary gear 22 and the third carrier 23c of the third planetary gear 23 are constantly coupled together, and the clutch C4 is provided to connect and disconnect the second ring gear 22r of the second planetary gear 22 and the third sun gear 23s of the third planetary gear 23 to and from each other. This can reduce the torque share of the clutch C4 as compared to a multi-speed transmission in which the clutch C4 is provided to connect and disconnect the third carrier 23c (the rotary element with a large torque share) of the third planetary gear 23 and the second carrier 22c of the second planetary gear 22 to and from each other like the multi-speed transmission of Patent Document 1 described above. The third carrier 23c of the third planetary gear 23 has a large torque share because torque corresponding to the torque of the third sun gear 23s and the torque of the third ring gear 23r is applied to the third carrier 23c. With this configuration, by disengaging the clutch C4 at the first forward speed, the second ring gear 22r of the second planetary gear 22 can be disconnected from the third sun gear 23s of the third planetary gear 23 that rotates at high speeds. This can restrain the second ring gear 22r with a large diameter from rotating at high speeds and having large inertia.

In the automatic transmission 20 of the present embodiment, the clutch C1 is provided to connect and disconnect the second sun gear 22s of the second planetary gear 22 (and the first ring gear 21r of the first planetary gear 21 and the fourth sun gear 24s of the fourth planetary gear 24) to and from the second ring gear 22r of the second planetary gear 22 (to allow and not to allow the second sun gear 22s, the second carrier 22c, and the second ring gear 22r to rotate together). This can reduce the torque share of the clutch C1 as compared to a multi-speed transmission in which the clutch C1 is provided to connect and disconnect the third carrier 23c (the rotary element with a large torque share) of the third planetary gear 23 to and from the first ring gear 21r of the first planetary gear 21 and the fourth sun gear 24s of the fourth planetary gear 24 like the multi-speed transmission of Patent Document 1 described above.

By thus reducing the torque shares of the clutch C1 and the clutch C4, the number of friction materials required for the clutch C1 and the clutch C4 can be reduced. This can reduce the axial length of the automatic transmission 20 and can also reduce drag loss that is caused by the clutch C1 and the clutch C4 when they are in a disengaged state, whereby efficiency of the automatic transmission 29 can be improved. By disengaging the clutch C4 at the first forward speed to restrain the second ring gear 22r of the second planetary gear 22 from having large inertia, the time required to engage the clutch C1 can be reduced, shift shock that occurs during engagement of the clutch C1 can be restrained, and durability of the friction materials of the clutch C1 can be improved. As a result, a lighter, more compact automatic transmission 20 can be implemented, and efficiency and shifting performance of the automatic transmission 20 and durability of the engagement elements can be improved.

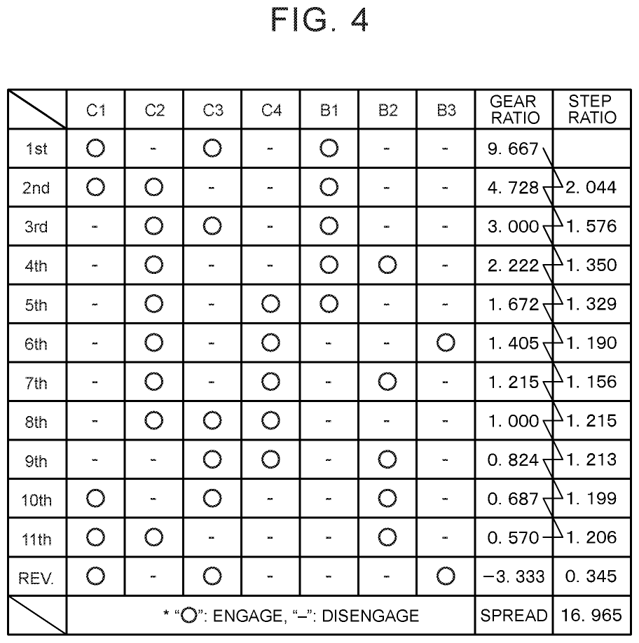

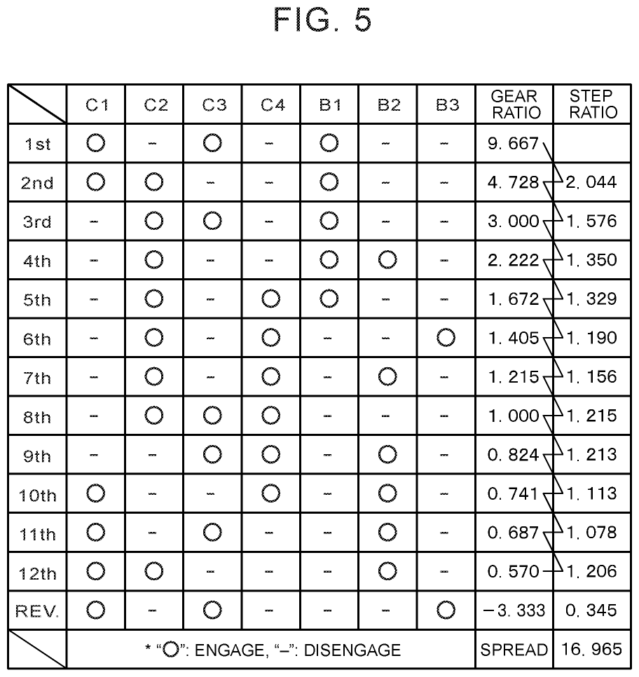

In the automatic transmission 20 of the power transmission device 10 of the above embodiment, as shown in the speed diagram of FIG. 2 and the operation table of FIG. 3, the automatic transmission 20 is used as a ten-speed transmission. However, the automatic transmission 20 may be used as an eleven-speed transmission as shown in the operation table of FIG. 4, or the automatic transmission 20 may be used as a twelve-speed transmission as shown in the operation table of FIG. 5. The operation table of FIG. 4 and the operation table of FIG. 5 will be described below in this order.

The operation table of FIG. 4 will be described. In the operation table of FIG. 4, the second to eleventh forward speeds correspond to the first to tenth forward speeds in the operation table of FIG. 3, respectively, and a new first forward speed is added. In the operation table of FIG. 4, the first forward speed is established by engaging the clutches C1, C3 and the brake B1 and disengaging the clutches C2, C4 and the brakes B2, B3. That is, when establishing the first forward speed, the second sun gear 22s of the second planetary gear 22 (and the first ring gear 21r of the first planetary gear 21 and the fourth sun gear 24s of the fourth planetary gear 24) is connected to the second ring gear 22r of the second planetary gear 22 by the clutch C1, the first carrier 21c of the first planetary gear 21 and the third sun gear 23s of the third planetary gear 23 are connected to each other by the clutch C3, and the third ring gear 23r of the third planetary gear 23 and the fourth ring gear 24r of the fourth planetary gear 24 are connected to the transmission case 11 and non-rotatably held stationary with respect to the transmission case 11 by the brake B1. In the present embodiment, the gear ratio γ1 at the first forward speed is γ1=9.667. The step ratio γ1/γ2 between the second forward speed and the second forward speed (the first forward speed in the operation table of FIG. 3) is γ1/γ2=2.044. The step ratio |γrev/γ1| between the first forward speed and the reverse speed is |γrev/γ1|=0.345. The spread γ1/γ11 in the automatic transmission 20 is γ1/γ10=16.995.

Since the first forward speed thus corresponds to a lower gear (a higher gear ratio), sufficiently large torque can be output to the rear wheels even if what is called a Hi-Lo switching mechanism (two-speed transmission) etc. is not provided to connect and disconnect the output shaft 20o to and from the right and left rear wheels, not shown. As a result, a lighter, more compact automatic transmission 20 can be implemented.

The operation table of FIG. 5 will be described. In the operation table of FIG. 5, the eleventh forward speed and the twelfth forward speed correspond to the tenth forward speed and the eleventh forward speed in the operation table of FIG. 4, respectively, and a new tenth forward speed is added. In the operation table of FIG. 5, the tenth forward speed is established by engaging the clutches C1, C4 and the brake B2. That is, when establishing the tenth forward speed, the second sun gear 22s of the second planetary gear 22 (and the first ring gear 21r of the first planetary gear 21 and the fourth sun gear 24s of the fourth planetary gear 24) is connected to the second ring gear 22r of the second planetary gear 22 by the clutch C1, the second ring gear 22r of the second planetary gear 22 and the third sun gear 23s of the third planetary gear 23 are connected to each other by the clutch C4, and the first sun gear 21s of the first planetary gear 21 is connected to the transmission case 11 and non-rotatably held stationary with respect to the transmission case 11 by the brake B2. In the present embodiment, the gear ratio γ10 at the tenth forward speed is γ10=0.741. The step ratio γ9/γ10 between the ninth forward speed and the tenth forward speed is γ9/γ10=1.113, and the step ratio γ10/γ11 between the tenth forward speed and the eleventh forward speed is γ10/γ11=1.078.

With the eleventh forward speed and the twelfth forward speed corresponding to the tenth forward speed and the eleventh forward speed in the operation table of FIG. 4, respectively, and the new tenth forward speed being added, further improvement in feeling during acceleration etc. can thus be achieved.

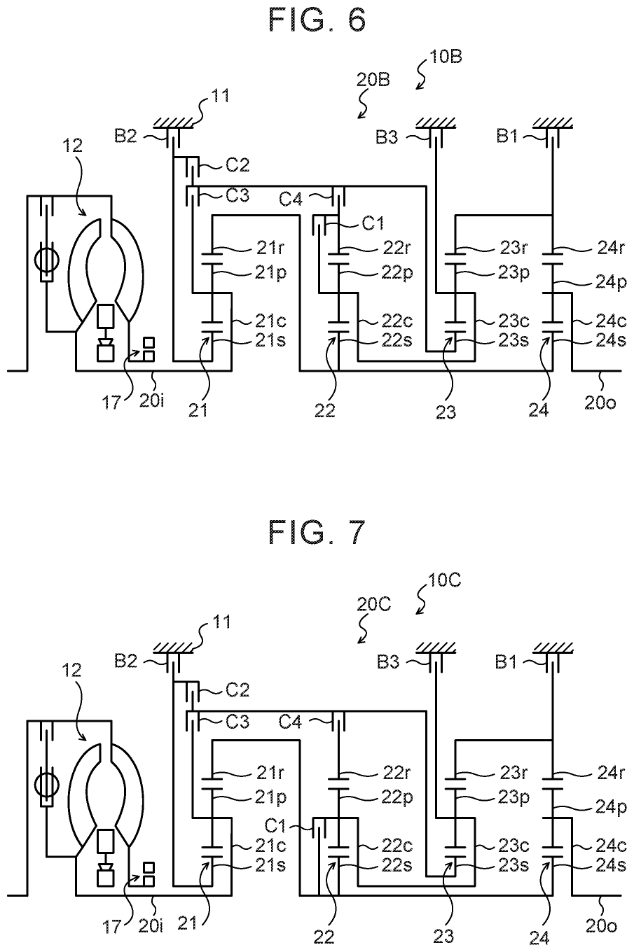

In the automatic transmission 20 of the power transmission device 10 of the above embodiment, as shown in FIG. 1, the clutch C1 connects and disconnects the second sun gear 22s of the second planetary gear 22 and the second ring gear 22r of the second planetary gear 22 to and from each other. However, as shown in an automatic transmission 20B of a power transmission device 10B of FIG. 6, the clutch C1 may connect and disconnect the second carrier 22c and the second ring gear 22r of the second planetary gear 22 to and from each other. Alternatively, as shown in an automatic transmission 20C of a power transmission device 10C of FIG. 7, the clutch C1 may connect and disconnect the second sun gear 22s and the second carrier 22c of the second planetary gear 22 to and from each other.

In the automatic transmissions 20, 20B, 20C of the power transmission devices 10, 10B, 10C of the above embodiments, the gear ratios λ1, λ2, λ3, λ4 of the first, second, third, and fourth planetary gears 21, 22, 23, 24 are 0.350, 0.400, 0.450, 0.500, respectively. However, the gear ratios λ1, λ2, λ3, λ4 of the first, second, third, and fourth planetary gears 21, 22, 23, 24 are not limited to these values.

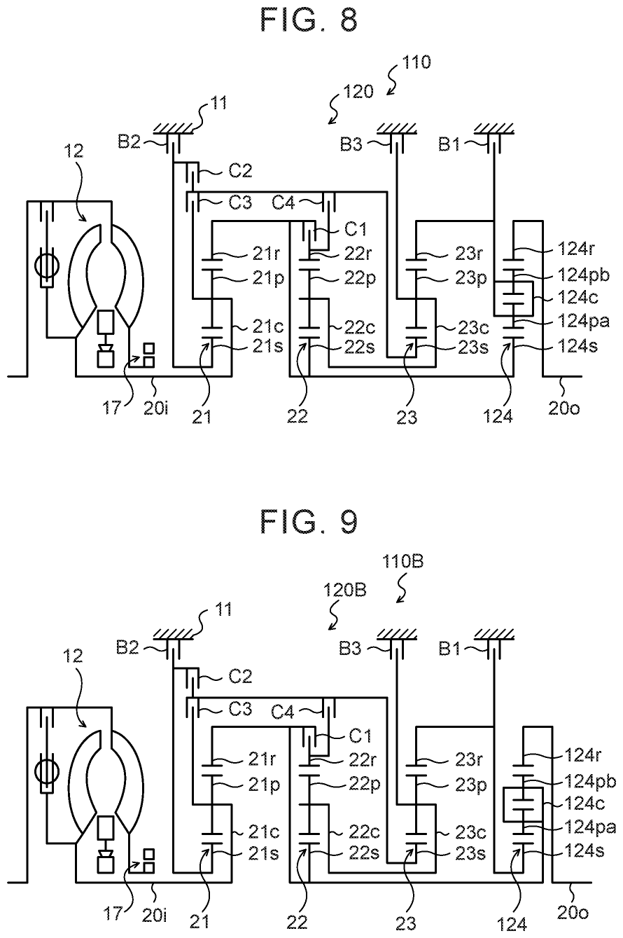

As shown in FIG. 1, the automatic transmission 20 of the power transmission device 10 of the above embodiment includes the single-pinion type first to fourth planetary gears 21 to 24. However, as shown in automatic transmissions 120, 120B of power transmission devices 110, 110B of FIGS. 8 and 9, the automatic transmission may include a double-pinion type planetary gear 24 instead of the single-pinion type planetary gear 24.

In the automatic transmissions 120, 120B of FIGS. 8 and 9, a fourth planetary gear 124 has a fourth sun gear 124s that is an external gear, a fourth ring gear 124r that is an internal gear disposed concentrically with the fourth sun gear 124s, a plurality of pinion gears 124pa each meshing with the fourth sun gear 124s, a plurality of pinion gears 124pb each meshing with a corresponding one of the pinion gears 124pa and the fourth ring gear 124r, and a fourth carrier 124c supporting the plurality of pinion gears 124pa and the plurality of pinion gears 124pb such that the plurality of pinion gears 124pa and the plurality of pinion gears 124pb can rotate and revolve.

In the automatic transmission 120 of FIG. 8, the fourth sun gear 124s of the fourth planetary gear 124 is constantly coupled to the first ring gear 21r of the first planetary gear 21 and the second sun gear 22s of the second planetary gear 22. The fourth carrier 24c of the fourth planetary gear 124 is constantly coupled to the third ring gear 23r of the third planetary gear 23. The fourth ring gear 124r of the fourth planetary gear 124 is constantly coupled to the output shaft 20o. The brake B1 connects the third ring gear 23r of the third planetary gear 23 and the fourth carrier 124c of the fourth planetary gear 124 to the transmission case 11 to non-rotatably hold the third ring gear 23r and the fourth carrier 124c stationary with respect to the transmission case 11, and releases the third ring gear 23r and the fourth carrier 124c from the transmission case 11.

In the automatic transmission 120B of FIG. 9, the fourth sun gear 124s of the fourth planetary gear 124 is constantly coupled to the third ring gear 23r of the third planetary gear 23. The fourth carrier 24c of the fourth planetary gear 124 is constantly coupled to the first ring gear 21r of the first planetary gear 21 and the second sun gear 22s of the second planetary gear 22. The fourth ring gear 124r of the fourth planetary gear 124 is constantly coupled to the output shaft 20o. The brake B1 connects the third ring gear 23r of the third planetary gear 23 and the fourth sun gear 124s of the fourth planetary gear 124 to the transmission case 11 to non-rotatably hold the third ring gear 23r and the fourth sun gear 124s stationary with respect to the transmission case 11, and releases the third ring gear 23r and the fourth sun gear 124s from the transmission case 11.

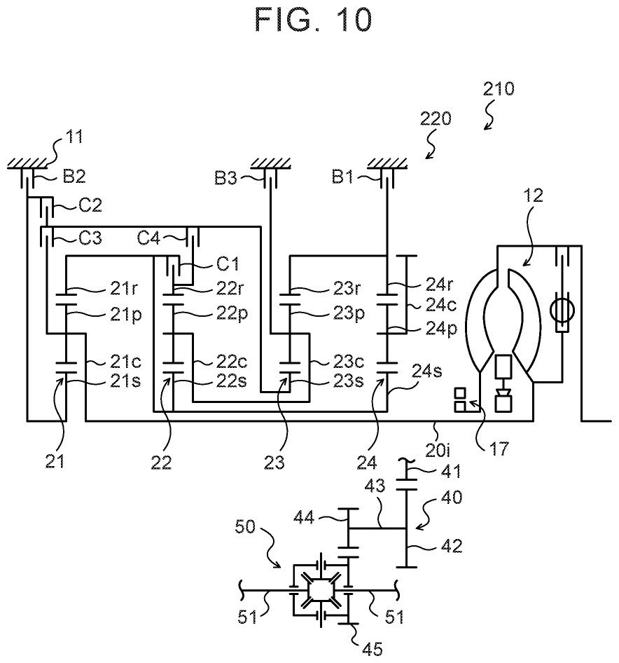

FIG. 10 is a configuration diagram schematically showing the configuration of a power transmission device 210 including an automatic transmission 220 according to a further embodiment of the present disclosure. The power transmission device 210 shown in FIG. 10 is connected to a crankshaft of an engine (internal combustion engine), not shown, serving as a driving source transversely mounted in a front part of a front-wheel drive vehicle and can transmit power (torque) from the engine to right and left front wheels (drive wheels), not shown. The automatic transmission 220 of the power transmission device 210 corresponds to the automatic transmission 20 of the above power transmission device 10 modified for front-wheel drive vehicles.

In the automatic transmission 220 shown in FIG. 10, the first carrier 21c of the first planetary gear 21 is constantly coupled to a counter drive gear 41 serving as an output member. Power (torque) transmitted from the automatic transmission 220 to the counter drive gear 41 is transmitted to the right and left front wheels via a gear train 40, which has, in addition to the counter drive gear 41, a counter driven gear 42 meshing with the counter drive gear 41, a drive pinion gear (final drive gear) 44 coupled to the counter driven gear 42 via a countershaft 43, and a differential ring gear (final driven gear) 45 meshing with the drive pinion gear 44, a differential gear 50 coupled to the differential ring gear 45, and drive shafts 51.

Similarly, the automatic transmissions 20B, 20C, 120, 120B of the above power transmission devices 10B, 10C, 110, 110B may be modified from automatic transmissions for rear-wheel drive vehicles to automatic transmissions for front-wheel drive vehicles.

In the automatic transmissions 20, 20B, 20C, 120, 120B of the power transmission devices 10, 10B, 10C, 110, 110B of the above embodiments, the clutches C1 to C4 and the brakes B1 to B3 are configured as friction engagement elements (hydraulic clutches, hydraulic brakes). However, at least one of the clutches C1 to C4 and the brakes B1 to B3 may be configured as a meshing element (dog clutch, dog brake).

As described above, the multi-speed transmission of the present disclosure is a multi-speed transmission (20, 20B, 20C, 120, 120B) that shifts power transmitted to an input member (20i) to transmit the shifted power to an output member (20o, 41). The multi-speed transmission (20, 20B, 20C, 120, 120B) includes: a first planetary gear (21), a second planetary gear (22), a third planetary gear (23), and a fourth planetary gear (24); and a first engagement element (C1), a second engagement element (C2), a third engagement element (C3), a fourth engagement element (C4), a fifth engagement element (B1), a sixth engagement element (B2), and a seventh engagement element (B3), each of which connects and disconnects one of rotary elements of the first planetary gear (21), the second planetary gear (22), the third planetary gear (23), and the fourth planetary gear (24) to and from another one of the rotary elements or a stationary member. The first planetary gear (21) is a single-pinion type planetary gear having a first sun gear (21s), a first ring gear (21r), and a first carrier (21c) that supports a plurality of first pinion gears (21p) such that the plurality of first pinion gears (21p) can rotate and revolve, each of the first pinion gears (21p) meshing with the first sun gear (21s) and the first ring gear (21r). The second planetary gear (22) is a single-pinion type planetary gear having a second sun gear (22s), a second ring gear (22r), and a second carrier (22c) that supports a plurality of second pinion gears (22p) such that the plurality of second pinion gears (22p) can rotate and revolve, each of the second pinion gears (22p) meshing with the second sun gear (22s) and the second ring gear (22r). The third planetary gear (23) is a single-pinion type planetary gear having a third sun gear (23s), a third ring gear (23r), and a third carrier (23c) that supports a plurality of third pinion gears (23p) such that the plurality of third pinion gears (23p) can rotate and revolve, each of the third pinion gears (23p) meshing with the third sun gear (23s) and the third ring gear (23r). The fourth planetary gear (24) has a first rotary element (24s, 124s, 124c), a second rotary element (24c, 124r), and a third rotary element (24r, 124c, 124s). The first carrier (21c) of the first planetary gear (21) is constantly coupled to the input member (20i). The second rotary element (24c, 124r) of the fourth planetary gear (24) is constantly coupled to the output member (20o, 41). The first ring gear (21r) of the first planetary gear (21), the second sun gear (22s) of the second planetary gear (22), and the first rotary element (24s, 124s, 124c) of the fourth planetary gear (24) are constantly coupled together. The second carrier (22c) of the second planetary gear (22) and the third carrier (23c) of the third planetary gear (23) are constantly coupled together. The third ring gear (23r) of the third planetary gear (23) and the third rotary element of the fourth planetary gear (24) are constantly coupled together. The first engagement element (C1) connects and disconnects two of the second sun gear (22s), the second carrier (22c), and the second ring gear (22r) of the second planetary gear (22) to and from each other. The fourth engagement element (C4) connects and disconnects the second ring gear (22r) of the second planetary gear (22) and the third sun gear (23s) of the third planetary gear (23) to and from each other. First to tenth forward speeds and a reverse speed, first to eleventh forward speeds and a reverse speed, or first to twelfth forward speeds and a reverse speed are established by selectively engaging three of the first engagement element (C1), the second engagement element (C2), the third engagement element (C3), the fourth engagement element (C4), the fifth engagement element (B1), the sixth engagement element (B2), and the seventh engagement element (B3).

In the multi-speed transmission of the present disclosure, the second carrier of the second planetary gear and the third carrier of the third planetary gear are constantly coupled together, and the fourth engagement element is provided to connect and disconnect the second ring gear of the second planetary gear and the third sun gear of the third planetary gear to and from each other. This can reduce the torque share of the fourth engagement element as compared to a multi-speed transmission in which the fourth engagement element is provided to connect and disconnect the third carrier (the rotary element with a large torque share) of the third planetary gear and the second carrier of the second planetary gear to and from each other like the multi-speed transmission of Patent Document 1 described above. By disengaging the fourth engagement element at a shift speed at which the third sun gear of the third planetary gear rotates at high speeds (e.g., the first forward speed), the second ring gear of the second planetary gear can be disconnected from the third sun gear of the third planetary gear. This can restrain the second ring gear with a large diameter from rotating at high speeds and having large inertia.

In the multi-speed transmission of the present disclosure, the first engagement element is provided to connect and disconnect two of the second sun gear, the second carrier, and the second ring gear of the second planetary gear to and from each other (to allow and not to allow the second sun gear, the second carrier, and the second ring gear to rotate together). This can reduce the torque share of the first engagement element as compared to a multi-speed transmission in which the first engagement element is provided to connect and disconnect the third carrier (the rotary element with a large torque share) of the third planetary gear to and from the first ring gear of the first planetary gear and the fourth sun gear (the rotary element corresponding to the first rotary element of the present disclosure) of the fourth planetary gear like the multi-speed transmission of Patent Document 1 described above.

By thus reducing the torque shares of the first engagement element and the fourth engagement element, the number of friction materials required for the first engagement element and the fourth engagement element can be reduced. This can reduce the axial length of the multi-speed transmission and can also reduce drag loss that is caused by the first engagement element and the fourth engagement element when they are in a disengaged state, whereby efficiency of the multi-speed transmission can be improved. By disengaging the fourth engagement element at the shift speed at which the third sun gear of the third planetary gear rotates at high speeds (e.g., the first forward speed) to restrain the second ring gear of the second planetary gear from having large inertia, the time required to engage the first engagement element can be reduced, shift shock that occurs during engagement of the first engagement element can be restrained, and durability of the friction materials of the first engagement element can be improved. As a result, a lighter, more compact multi-speed transmission can be implemented, and efficiency and shifting performance of the multi-speed transmission and durability of the engagement elements can be improved.

In the multi-speed transmission of the present disclosure, the fourth planetary gear (24) may be a single-pinion type planetary gear having a fourth sun gear (24s), a fourth ring gear (24r), and a fourth carrier (24c) that supports a plurality of fourth pinion gears (24p) such that the plurality of fourth pinion gears (24p) can rotate and revolve, each of the fourth pinion gears (24p) meshing with the fourth sun gear (24s) and the fourth ring gear (24r), the first rotary element may be the fourth sun gear (24s), the second rotary element may be the fourth carrier (24c), and the third rotary element may be the fourth ring gear (24r).

In the multi-speed transmission of the present disclosure, the fourth planetary gear (124) may be a double-pinion type planetary gear having a fourth sun gear (124s), a fourth ring gear (124r), and a fourth carrier (124c) that supports a plurality of pairs of pinion gears (124pa, 124pb) such that the plurality of pairs of pinion gears (124pa, 124pb) can rotate and revolve, the pinion gears (124pa, 124pb) in each pair meshing with each other with one of the pinion gears (124pa, 124pb) meshing with the fourth sun gear (124s) and the other meshing with the fourth ring gear (24r), the first rotary element may be the fourth sun gear (124s), the second rotary element may be the fourth ring gear (124r), and the third rotary element may be the fourth carrier (124c).

In the multi-speed transmission (120B) of the present disclosure, the fourth planetary gear (124) may be a double-pinion type planetary gear having a fourth sun gear (124s), a fourth ring gear (124r), and a fourth carrier (124c) that supports a plurality of pairs of pinion gears (124pa, 124pb) such that the plurality of pairs of pinion gears (124pa, 124pb) can rotate and revolve, the pinion gears (124pa, 124pb) in each pair meshing each other with one of the pinion gears (124pa, 124pb) meshing with the fourth sun gear (124s) and the other meshing with the fourth ring gear (24r), the first rotary element may be the fourth carrier (124c), the second rotary element may be the fourth ring gear (124r), and the third rotary element may be the fourth sun gear (124s).

In the multi-speed transmission of the present disclosure, the second engagement element (C2) may connect and disconnect the first sun gear (21s) of the first planetary gear (21) and the third sun gear (23s) of the third planetary gear (23) to and from each other, the third engagement element (C3) may connect and disconnect the first carrier (21c) of the first planetary gear (21) and the third sun gear (23s) of the third planetary gear (23) to and from each other, the fifth engagement element (B1) may connect the third ring gear (23r) of the third planetary gear (23) and the third rotary element (24r, 124c, 124s) of the fourth planetary gear (24) to the stationary member (11) to non-rotatably hold the third ring gear (23r) and the third rotary element (24r, 124c, 124s) stationary with respect to the stationary member (11), and release the third ring gear (23r) and the third rotary element (24r, 124c, 124s) from the stationary member (11), the sixth engagement element (B2) may connect the first sun gear (21s) of the first planetary gear (21) to the stationary member (11) to non-rotatably hold the first sun gear (21s) stationary with respect to the stationary member (11), and release the first sun gear (21s) from the stationary member (11), and the seventh engagement element (B3) may connect the third carrier (23c) of the third planetary gear (23) to the stationary member (11) to non-rotatably hold the third carrier (23c) stationary with respect to the stationary member (11), and release the third carrier (23c) from the stationary member (11).

In the multi-speed transmission of the present disclosure, the first forward speed may be established by engaging the first engagement element (C1), the second engagement element (C2), and the fifth engagement element (B1), the second forward speed may be established by engaging the second engagement element (C2), the third engagement element (C3), and the fifth engagement element (B1), the third forward speed may be established by engaging the second engagement element (C2), the fifth engagement element (B1), and the sixth engagement element (B2), the fourth forward speed may be established by engaging the second engagement element (C2), the fourth engagement element (C4), and the fifth engagement element (B1), the fifth forward speed may be established by engaging the second engagement element (C2), the fourth engagement element (C4), and the seventh engagement element (B3), the sixth forward speed may be established by engaging the second engagement element (C2), the fourth engagement element (C4), and the sixth engagement element (B2), the seventh forward speed may be established by engaging the second engagement element (C2), the third engagement element (C3), and the fourth engagement element (C4), the eighth forward speed may be established by engaging the third engagement element (C3), the fourth engagement element (C4), and the sixth engagement element (B2), the ninth forward speed may be established by engaging the first engagement element (C1), the third engagement element (C3), and the sixth engagement element (B2), the tenth forward speed may be established by engaging the first engagement element (C1), the second engagement element (C2), and the sixth engagement element (B2), and the reverse speed may be established by engaging the first engagement element (C1), the third engagement element (C3), and the seventh engagement element (B3).

In the multi-speed transmission of the present disclosure, the first forward speed may be established by engaging the first engagement element (C1), the third engagement element (C3), and the fifth engagement element (B1), the second forward speed may be established by engaging the first engagement element (C1), the second engagement element (C2), and the fifth engagement element (B1), the third forward speed may be established by engaging the second engagement element (C2), the third engagement element (C3), and the fifth engagement element (B1), the fourth forward speed may be established by engaging the second engagement element (C2), the fifth engagement element (B1), and the sixth engagement element (B2), the fifth forward speed may be established by engaging the second engagement element (C2), the fourth engagement element (C4), and the fifth engagement element (B1), the sixth forward speed may be established by engaging the second engagement element (C2), the fourth engagement element (C4), and the seventh engagement element (B3), the seventh forward speed may be established by engaging the second engagement element (C2), the fourth engagement element (C4), and the sixth engagement element (B2), the eighth forward speed may be established by engaging the second engagement element (C2), the third engagement element (C3), and the fourth engagement element (C4), the ninth forward speed may be established by engaging the third engagement element (C3), the fourth engagement element (C4), and the sixth engagement element (B2), the tenth forward speed may be established by engaging the first engagement element (C1), the third engagement element (C3), and the sixth engagement element (B2), the eleventh forward speed may be established by engaging the first engagement element (C1), the second engagement element (C2), and the sixth engagement element (B2), and the reverse speed may be established by engaging the first engagement element (C1), the third engagement element (C3), and the seventh engagement element (B3).

In the multi-speed transmission of the present disclosure, the first forward speed may be established by engaging the first engagement element (C1), the third engagement element (C3), and the fifth engagement element (B1), the second forward speed may be established by engaging the first engagement element (C1), the second engagement element (C2), and the fifth engagement element (B1), the third forward speed may be established by engaging the second engagement element (C2), the third engagement element (C3), and the fifth engagement element (B1), the fourth forward speed may be established by engaging the second engagement element (C2), the fifth engagement element (B1), and the sixth engagement element (B2), the fifth forward speed may be established by engaging the second engagement element (C2), the fourth engagement element (C4), and the fifth engagement element (B1), the sixth forward speed may be established by engaging the second engagement element (C2), the fourth engagement element (C4), and the seventh engagement element (B3), the seventh forward speed may be established by engaging the second engagement element (C2), the fourth engagement element (C4), and the sixth engagement element (B2), the eighth forward speed may be established by engaging the second engagement element (C2), the third engagement element (C3), and the fourth engagement element (C4), the ninth forward speed may be established by engaging the third engagement element (C3), the fourth engagement element (C4), and the sixth engagement element (B2), the tenth forward speed may be established by engaging the first engagement element (C1), the fourth engagement element (C4), and the sixth engagement element (B2), the eleventh forward speed may be established by engaging the first engagement element (C1), the third engagement element (C3), and the sixth engagement element (B2), the twelfth forward speed may be established by engaging the first engagement element (C1), the second engagement element (C2), and the sixth engagement element (B2), and the reverse speed may be established by engaging the first engagement element (C1), the third engagement element (C3), and the seventh engagement element (B3).

In the multi-speed transmission of the present disclosure, the output member may be an output shaft (20o) coupled to a rear wheel of a vehicle via a differential gear. Alternatively, the output member may be a counter drive gear (41) included in a gear train (40) that transmits the power to a differential gear (50) coupled to a front wheel of a vehicle.

Although embodiments for carrying out the present disclosure are described above, it should be understood that the present disclosure is not limited in any way to the embodiments and can be carried out in various forms without departing from the spirit and scope of the present disclosure.

### INDUSTRIAL APPLICABILITY

The present disclosure is applicable to manufacturing industries of multi-speed transmissions, etc.

1. A multi-speed transmission that shifts power transmitted to an input member to transmit the shifted power to an output member, comprising:
a first planetary gear, a second planetary gear, a third planetary gear, and a fourth planetary gear; and
a first engagement element, a second engagement element, a third engagement element, a fourth engagement element, a fifth engagement element, a sixth engagement element, and a seventh engagement element, each of which connects and disconnects one of rotary elements of the first planetary gear, the second planetary gear, the third planetary gear, and the fourth planetary gear to and from another one of the rotary elements or a stationary member, wherein
the first planetary gear is a single-pinion type planetary gear having a first sun gear, a first ring gear, and a first carrier that supports a plurality of first pinion gears such that the plurality of first pinion gears can rotate and revolve, each of the first pinion gears meshing with the first sun gear and the first ring gear,
the second planetary gear is a single-pinion type planetary gear having a second sun gear, a second ring gear, and a second carrier that supports a plurality of second pinion gears such that the plurality of second pinion gears can rotate and revolve, each of the second pinion gears meshing with the second sun gear and the second ring gear,
the third planetary gear is a single-pinion type planetary gear having a third sun gear, a third ring gear, and a third carrier that supports a plurality of third pinion gears such that the plurality of third pinion gears can rotate and revolve, each of the third pinion gears meshing with the third sun gear and the third ring gear,
the fourth planetary gear has a first rotary element, a second rotary element, and a third rotary element,
the first carrier of the first planetary gear is constantly coupled to the input member,
the second rotary element of the fourth planetary gear is constantly coupled to the output member,
the first ring gear of the first planetary gear, the second sun gear of the second planetary gear, and the first rotary element of the fourth planetary gear are constantly coupled together,
the second carrier of the second planetary gear and the third carrier of the third planetary gear are constantly coupled together,
the third ring gear of the third planetary gear and the third rotary element of the fourth planetary gear are constantly coupled together,
the first engagement element connects and disconnects two of the second sun gear, the second carrier, and the second ring gear of the second planetary gear to and from each other,
the fourth engagement element connects and disconnects the second ring gear of the second planetary gear and the third sun gear of the third planetary gear to and from each other, and
first to tenth forward speeds and a reverse speed, first to eleventh forward speeds and a reverse speed, or first to twelfth forward speeds and a reverse speed are established by selectively engaging three of the first engagement element, the second engagement element, the third engagement element, the fourth engagement element, the fifth engagement element, the sixth engagement element, and the seventh engagement element.

2. The multi-speed transmission according to claim 1, wherein
the fourth planetary gear is a single-pinion type planetary gear having a fourth sun gear, a fourth ring gear, and a fourth carrier that supports a plurality of fourth pinion gears such that the plurality of fourth pinion gears can rotate and revolve, each of the fourth pinion gears meshing with the fourth sun gear and the fourth ring gear,
the first rotary element is the fourth sun gear,
the second rotary element is the fourth carrier, and
the third rotary element is the fourth ring gear.

3. The multi-speed transmission according to claim 1, wherein
the fourth planetary gear is a double-pinion type planetary gear having a fourth sun gear, a fourth ring gear, and a fourth carrier that supports a plurality of pairs of pinion gears such that the plurality of pairs of pinion gears can rotate and revolve, the pinion gears in each pair meshing with each other with one of the pinion gears meshing with the fourth sun gear and the other meshing with the fourth ring gear,
the first rotary element is the fourth sun gear,
the second rotary element is the fourth ring gear, and
the third rotary element is the fourth carrier.

4. The multi-speed transmission according to claim 1, wherein
the fourth planetary gear is a double-pinion type planetary gear having a fourth sun gear, a fourth ring gear, and a fourth carrier that supports a plurality of pairs of pinion gears such that the plurality of pairs of pinion gears can rotate and revolve, the pinion gears in each pair meshing each other with one of the pinion gears meshing with the fourth sun gear and the other meshing with the fourth ring gear,
the first rotary element is the fourth carrier,
the second rotary element is the fourth ring gear, and
the third rotary element is the fourth sun gear.

5. The multi-speed transmission according to claim 1, wherein
the second engagement element connects and disconnects the first sun gear of the first planetary gear and the third sun gear of the third planetary gear to and from each other,
the third engagement element connects and disconnects the first carrier of the first planetary gear and the third sun gear of the third planetary gear to and from each other,
the fifth engagement element connects the third ring gear of the third planetary gear and the third rotary element of the fourth planetary gear to the stationary member to non-rotatably hold the third ring gear and the third rotary element stationary with respect to the stationary member, and releases the third ring gear and the third rotary element from the stationary member,
the sixth engagement element connects the first sun gear of the first planetary gear to the stationary member to non-rotatably hold the first sun gear stationary with respect to the stationary member, and releases the first sun gear from the stationary member, and
the seventh engagement element connects the third carrier of the third planetary gear to the stationary member to non-rotatably hold the third carrier stationary with respect to the stationary member, and releases the third carrier from the stationary member.

6. The multi-speed transmission according to claim 5, wherein
the first forward speed is established by engaging the first engagement element, the second engagement element, and the fifth engagement element,
the second forward speed is established by engaging the second engagement element, the third engagement element, and the fifth engagement element,
the third forward speed is established by engaging the second engagement element, the fifth engagement element, and the sixth engagement element,
the fourth forward speed is established by engaging the second engagement element, the fourth engagement element, and the fifth engagement element,
the fifth forward speed is established by engaging the second engagement element, the fourth engagement element, and the seventh engagement element,
the sixth forward speed is established by engaging the second engagement element, the fourth engagement element, and the sixth engagement element,
the seventh forward speed is established by engaging the second engagement element, the third engagement element, and the fourth engagement element,
the eighth forward speed is established by engaging the third engagement element, the fourth engagement element, and the sixth engagement element,
the ninth forward speed is established by engaging the first engagement element, the third engagement element, and the sixth engagement element,
the tenth forward speed is established by engaging the first engagement element, the second engagement element, and the sixth engagement element, and
the reverse speed is established by engaging the first engagement element, the third engagement element, and the seventh engagement element.

7. The multi-speed transmission according to claim 5, wherein
the first forward speed is established by engaging the first engagement element, the third engagement element, and the fifth engagement element,
the second forward speed is established by engaging the first engagement element, the second engagement element, and the fifth engagement element,
the third forward speed is established by engaging the second engagement element, the third engagement element, and the fifth engagement element,
the fourth forward speed is established by engaging the second engagement element, the fifth engagement element, and the sixth engagement element,
the fifth forward speed is established by engaging the second engagement element, the fourth engagement element, and the fifth engagement element,
the sixth forward speed is established by engaging the second engagement element, the fourth engagement element, and the seventh engagement element,
the seventh forward speed is established by engaging the second engagement element, the fourth engagement element, and the sixth engagement element,
the eighth forward speed is established by engaging the second engagement element, the third engagement element, and the fourth engagement element,
the ninth forward speed is established by engaging the third engagement element, the fourth engagement element, and the sixth engagement element,
the tenth forward speed is established by engaging the first engagement element, the third engagement element, and the sixth engagement element,
the eleventh forward speed is established by engaging the first engagement element, the second engagement element, and the sixth engagement element, and
the reverse speed is established by engaging the first engagement element, the third engagement element, and the seventh engagement element.

8. The multi-speed transmission according to claim 5, wherein
the first forward speed is established by engaging the first engagement element, the third engagement element, and the fifth engagement element,
the second forward speed is established by engaging the first engagement element, the second engagement element, and the fifth engagement element,
the third forward speed is established by engaging the second engagement element, the third engagement element, and the fifth engagement element,
the fourth forward speed is established by engaging the second engagement element, the fifth engagement element, and the sixth engagement element,
the fifth forward speed is established by engaging the second engagement element, the fourth engagement element, and the fifth engagement element,
the sixth forward speed is established by engaging the second engagement element, the fourth engagement element, and the seventh engagement element,
the seventh forward speed is established by engaging the second engagement element, the fourth engagement element, and the sixth engagement element,
the eighth forward speed is established by engaging the second engagement element, the third engagement element, and the fourth engagement element,
the ninth forward speed is established by engaging the third engagement element, the fourth engagement element, and the sixth engagement element,
the tenth forward speed is established by engaging the first engagement element, the fourth engagement element, and the sixth engagement element,
the eleventh forward speed is established by engaging the first engagement element, the third engagement element, and the sixth engagement element,
the twelfth forward speed is established by engaging the first engagement element, the second engagement element, and the sixth engagement element, and
the reverse speed is established by engaging the first engagement element, the third engagement element, and the seventh engagement element.

9. The multi-speed transmission according to claim 1, wherein
the output member is an output shaft coupled to a rear wheel of a vehicle via a differential gear.

10. The multi-speed transmission according to claim 1, wherein
the output member is a counter drive gear included in a gear train that transmits the power to a differential gear coupled to a front wheel of a vehicle.
